(19) United States
(12) Patent Application Publication
(10) Pub. No.: US 2025/0111130 A1
(43) Pub. Date: Apr. 3, 2025

(54) SYSTEM AND METHOD FOR CANVAS SANITIZATION

(71) Applicant: CA, Inc., San Jose, CA (US)

(72) Inventor: Ophir Back, Petah Tikva (IL)

(21) Appl. No.: 18/479,358

(22) Filed: Oct. 2, 2023

(51) Int. Cl. G06F 40/14; G06T 11/00

(52) U.S. Cl. CPC G06F 40/14; G06T 11/00; G06T 2200/24

(57) ABSTRACT

Novel systems and methods for canvas sanitization are provided. In various embodiments, a system and method include: receiving a request to open a web page from a client device; replacing, via an agent, a first function with a second function, the agent being loaded to a browser; loading the web page from a web server to the browser; in response to an attempt to perform the first function on the web page, performing, via the browser, the second function corresponding to the first function to generate a drawing for a predetermined period of time; converting, via the agent, the drawing to an image; and transmitting the image to the client device. Other aspects, embodiments, and features are also claimed and described.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for remote browser isolation technology.

### BACKGROUND

With the rapid growth of the internet, web browsing has become an indispensable part of daily living. However, along with the convenience and accessibility of online resources, there has been a rise in cyber threats such as malware, ransomware, and phishing attacks. These threats exploit vulnerabilities in web browsers to gain unauthorized access to end-user systems, compromising their sensitive information, financial assets, and overall digital security. As the demand for web browsing continues to increase, research and development continue to advance web browsing technologies not only to prevent unauthorized access to end-user systems, but to advance and enhance the user experience with web browsing. According to some approaches, techniques such as canvas sanitization may be used. For example, the term “canvas sanitization” refers to a security mechanism that helps to remove unsafe (and potentially malicious) content from untrusted or potentially malicious web contents before presenting them to the user. While existing canvas sanitization techniques have been proposed, they are were inadequate for the reasons explained below.

### SUMMARY

In an aspect, a method for canvas sanitization includes: receiving a request to open a web page from a client device; replacing, via an agent, a first function with a second function, the agent being loaded to a browser; loading the web page from a web server to the browser; in response to an attempt to perform the first function on the web page, performing, via the browser, the second function corresponding to the first function to generate a drawing for a first period of time; converting, via the agent, the drawing to an image; and transmitting the image to the client device.

In some embodiments, the agent being loaded to the browser is prior to the loading of the web page from the web server to the browser.

In some embodiments, the agent comprises a proxy, and the replacing of the predefined drawing function comprises: redefining the first function to the second function.

According to some embodiments, the first function is configured to be performed using a drawing parameter, and the second function is configured to be performed using the drawing parameter.

In some embodiments, the loading of the web page comprises: receiving the web page from the web server; and generating a drawing object of a hypertext markup language canvas element on the browser based on the web page. In some embodiments, the first function is configured to be performed based on the drawing object.

According to some embodiments, the performing of the second function comprises: performing the second function on the browser based on the drawing object.

According to some embodiments, the method further comprises: initiating a timer for the first period of time, wherein the timer is associated with the drawing object.

According to some embodiments, the drawing comprises a first partial drawing. In some embodiments, the method further comprises: performing, via the agent, the second function corresponding to the first function to generate a second partial drawing for a second period of time; and aggregating, via the agent, the first partial drawing and the second partial drawing to generate an aggregated drawing. In some embodiments, the converting of the drawing comprises: converting the aggregated drawing to the image.

According to some embodiments, the method further comprises: receiving a user input to indicate a change to the drawing object. In some embodiments, the change to the drawing object comprises the attempt to perform the first function.

In some embodiments, the attempt to perform the first function comprises: completing a command on the web page prior to a call of the first function.

In some embodiments, the drawing comprises an object drawn by the second function. In some embodiments, the converting of the drawing comprises: converting the object to the image.

In a further aspect, a server comprises: a memory storing a browser and an agent; a processor coupled to the memory, and a communication system coupled to the processor. In some embodiments, the processor coupled to the memory is configured to: receive, via the communication system, a request to open a web page from a client device; replace, via an agent, a first function with a second function, the agent being loaded to the browser; load, via the browser, the web page from a web server; in response to an attempt to perform the first function on the web page, perform, via the agent, the second function corresponding to the first function to generate a drawing for a first period of time; convert, via the agent, the drawing to an image; and transmit, via the communication system, the image to the client device.

In some embodiments, the agent comprises a proxy, and to replace the first function, the processor is configured to: redefine the first function to the second function.

According to some embodiments, the first function comprises a drawing parameter. In some embodiments, to perform the second function, the processor is configured to: perform the second function based on the drawing parameter.

According to some embodiments, to load the web page, the processor is configured to: receive the web page from the web server; and generate a drawing object of a hypertext markup language canvas element on the browser based on the web page, wherein the first function is configured to be performed based on the drawing object.

According to some embodiments, to perform the second function, the processor is configured to: perform the second function on the browser based on the drawing object.

According to some embodiments, the processor is further configured to: initiate a timer for the first period of time, wherein the timer is associated with the drawing object.

According to some embodiments, the drawing comprises a first partial drawing. In some embodiments, the processor is further configured to: perform, via the agent, the second function corresponding to the first function to generate a second partial drawing for a second period of time; and aggregate, via the agent, the first partial drawing and the second partial drawing to generate an aggregated drawing. In some embodiments, to convert the drawing, the processor is configured to: convert the aggregated drawing to the image.

According to some embodiments, the processor is further configured to: receive a user input to indicate a change to the drawing object. In some embodiments, the change to the drawing object comprises the attempt to perform the first function.

In a further aspect, a server comprises: a memory storing a browser and an agent; a processor coupled to the memory, and a communication system coupled to the processor. In some embodiments, the processor coupled to the memory is configured to: receive, via the communication system, a request to open a page from a client device; loading an agent to the browser; override, via the agent, a first function with a second function; load, via the browser, the web page from a web server; in response to an attempt to perform the first function on the web page, perform, via the agent, the second function corresponding to the first function to generate a drawing for a first period of time; convert, via the agent, the drawing to an image; and transmit, via the communication system, the image to the client device.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates an example computing environment for canvas sanitization, in accordance with various embodiments.

FIG. 2 is a flow chart illustrating an example process for canvas sanitization, in accordance with various embodiments.

FIG. 3 is a call flow diagram illustrating an example process for canvas sanitization, in accordance with various embodiments.

FIG. 4 is a schematic diagram illustrating example canvas sanitization, in accordance with various embodiments.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

As described above, cyber threats to exploit vulnerabilities in web browsers are increasing. For example, HTML (Hypertext Markup Language) offer the use of canvas elements, which can load graphic data from multiple sources. In some cases, the data might include malicious parts that can attempt to interfere with the proper loading of the browser and even endanger user's data and security if a vulnerability in the browser was exploited. Recently, remote browser isolation technologies tried to address the challenges posed by web-based threats. Remote browser isolation involves executing web browsers in a controlled and secure environment outside the user's local device or the client device. Instead of rendering web pages directly on the user device, the technology processes and renders web content on remote servers, and only safe visual information is transmitted back to the user device. This way, any potentially harmful code or malicious content remains isolated from the local environment, substantially reducing the risk of cyber-attacks and providing a safer web browsing experience. However, the existing remote browser isolation technologies can only be implemented by intercepting web traffic. Thus, the existing remote browser isolation technologies are computationally expensive in that all web traffic has to be analyzed to determine which part of the web page is in need to be processed in the remote browser. In addition, the existing remote browser isolation technologies have to send more than necessary web browsing data from the predefined web server to the user device. Thus, the existing remote browser isolation technologies exhibit latency issues due to the overhead involved in monitoring web traffic between the predefined web server and the user device and transmitting visual content between the remote server and the user device. Additionally, there have been challenges in maintaining a seamless user experience across various web applications, especially those heavily reliant on real-time interactions and multimedia content.

Furthermore, the existing remote browser isolation technologies sometimes modify the browser's code of the local or client device to integrate the custom code into the browser itself during compilation to intercept the web traffic and transmit data to a remote server, which includes the remote browser. However, this requires each local browser to be complied again for the custom code to be integrated into the local browser. This eventually leads to an unnecessary time to use the existing remote browser isolation technologies and exploits another vulnerability due to the modified browser.

Some embodiments described herein provide solutions to these problems by intercepting function calls or code rather than intercepting web traffic. This enables dynamic tracking of canvas elements while imposing minimal or no impact on website performance. In addition, some embodiments described herein further provide a timer to convert and send a sequence of images of a web page to the user or client device. This facilitates real-time interactions without or minimal latency, and the user or client device does not need to experience the overhead to receive one big image file. In addition, the improved system and method for canvas sanitization also provide various other aspects described herein.

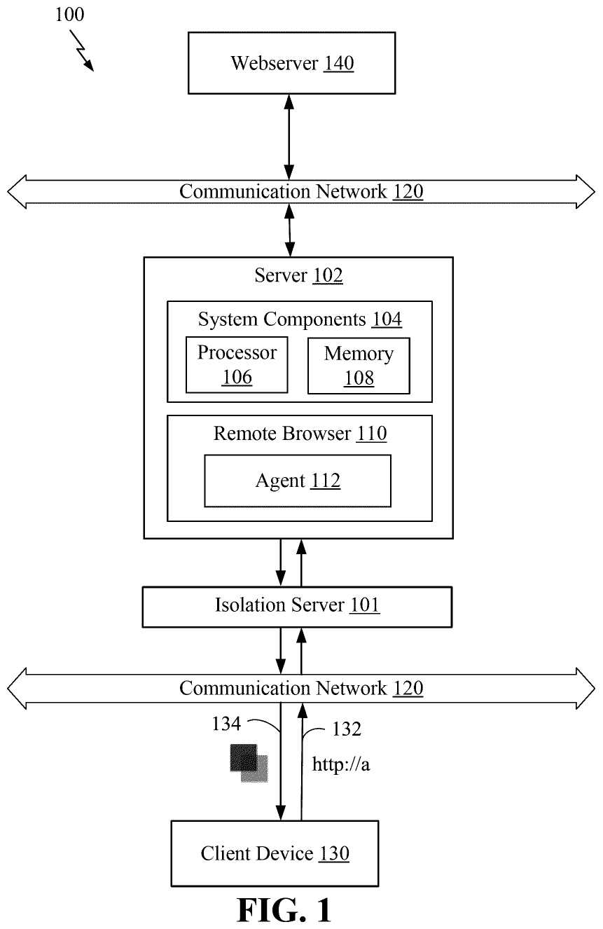

FIG. 1 illustrates an example computing environment 100 for canvas sanitization, in accordance with various embodiments. In the example computing environment 100, a user can open a web page on a local browser in a client device 130. Then, the client device 130 can transmit a request to open the web page to an isolation server 101, and the isolation server 101 can transmit the request to a server 102 including a remote browser 110 over a communication network 120. Thus, the server 102 can receive, (e.g., via the communication subsystem), the request to open the web page from the client device 130, and the agent 112 can override a first function (e.g., a canvas drawing function). In some examples, the isolation server 101 or the server 102 can load an agent 112 to the remote browser 110. Then, the server 102 can load the web page from a web server 140 to the remote browser 110 over the communication network 120. Then, the agent 112 can intercept a drawing function of the web page, perform a second function to generate a drawing, convert the drawing to an image, and transmit the image 134 to the client device 130 over the communication network 120.

The embodiment shown in FIG. 1 is one example of a computing system environment and is not intended to be limiting. The subsystems and components within the server 102, the isolation server 101, and the client device 130 can be implemented in hardware, firmware, software, or combinations thereof. In some examples, a user operating the client computing device 130 can utilize a client applications to interact with the isolation server 101, which communicates with the server 102 to browse the web page from the web server 140. The client device 130 can be configured to transmit a request to open the web page to the server 102 and receive an image, which is converted from a drawing configured to be drawn based on a drawing function of the web page over the communication network 120. Such client applications can be a web browser, web browser-based applications, standalone software applications, such as mobile device applications, or any other suitable client applications configured to communicatively connect to any web server 140 over the communication network 120. In some examples, the client device 130 can include a user device (e.g., a personal computer, a laptop, a tablet, a mobile device, or any other suitable user device). In other examples, the client device 130 can include an intermediate device to forwarding, deliver, and/or route data between the server 101 and an end device. In further examples, the client device 130 can include another server, a web server, or any other suitable device. In some examples, the client device 130 may only communicate with the isolation server 101 to protect the client device 130 from malicious or harmful contents to access the client device 130.

In some examples, the client device 130, the isolation server 101, the server 102, the remote browser 110, the agent 112, the web server 140, and/or any other disclosed devices can be communicatively coupled via the communication network 120. The communication network 120 can be any type of network known in the art supporting data communications. As non-limiting examples, the communication network 120 can be a local area network (LAN; e.g., Ethernet, Token-Ring, etc.), a wide-area network (e.g., the Internet), an infrared or wireless network, a public switched telephone networks (PSTNs), a virtual network, a wired network, etc. The communication network 120 can use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

In some examples, the isolation server 101 can include a processor coupled to a memory to perform various tasks on behalf of the client device 130. In some examples, the isolation server 101 can further include a communications subsystem to provide a communication interface from the server 101 and other computing devices via the communication network 120. Thus, the processor via the communication subsystem can communicate with the client device 130 and the server 102. In some examples, the isolation server 101 can verify authorization of the client device 130 and act on behalf of the client device 130. In further examples, the isolation server 101 can store the agent 112 in the memory and load the agent 112 to a browser (e.g., a remote browser) in the server 102. In some examples, the isolation server 101 can the only entity capable of interacting with the agent 112 and the browser 110 of the server 102. In other examples, the isolation server 101 can interact with other computing devices or server. In further examples, the isolation server 101 and the server 102 including the browser 110 and the agent 112 can be physically separated entities. In other examples, the isolation server 101 and the server 102 are logically separated processes, which communicate each other. In further examples, the isolation server 101 can be in the same or different cloud environment as or from the server 102.

In some examples, various different system components 104 can be implemented on server 102. The server 102 can be configured to run one or more server software applications or services, for example, web-based or cloud-based services, to support interaction with the browser 110, the isolation server 101, and/or the web server 140. For example, the system components 104 can include a processor 106, which can communicate (e.g., interface) with a number of peripheral subsystems in the system components 104 via a bus subsystem. These peripheral subsystems may include, for example, a memory 108, an input/output (I/O) subsystem, and a communications subsystem.

In some examples, the processor 106 can be implemented as one or more integrated circuits (e.g., a conventional micro-processor or microcontroller). In an example, the processor 106 can control the operation of the server 102. The processor 106 can include single core and/or multicore (e.g., quad core, hexa-core, octo-core, ten-core, etc.) processors and processor caches. The processor 106 can execute a variety of resident software processes embodied in program code, and may maintain multiple concurrently executing programs or processes. In some examples, the processor 106 may include a specialized processor, (e.g., digital signal processor (DSP), outboard, graphics application-specific, and/or other processor).

In some examples, the bus subsystem provides a mechanism for intended communication between the various components in the server 102. The bus subsystem can utilize a single bus or multiple buses. In some examples, the bus subsystem may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

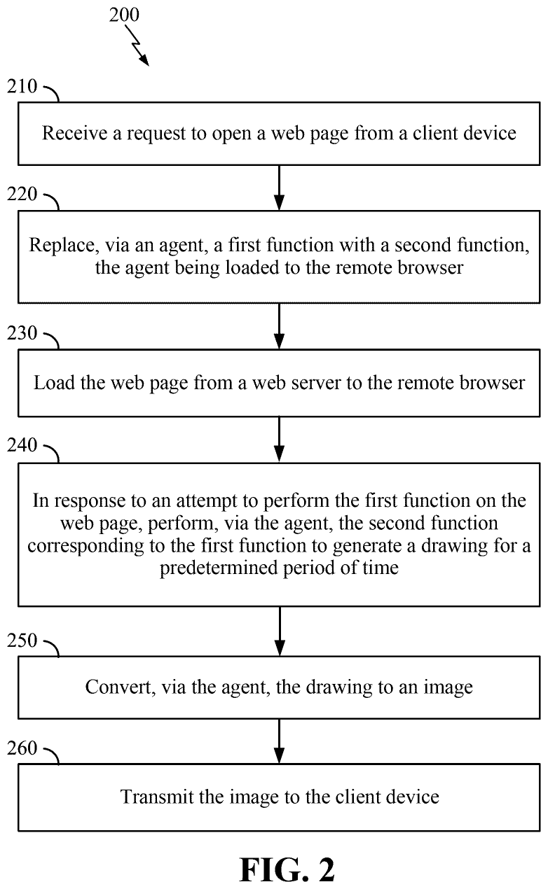

In some examples, the system components 104 of the server 102 can further include a memory 108, which is a non-transitory storage medium. The memory 108 can include any suitable storage device or devices that can be used to store suitable data (e.g., the agent 112, the browser 110, etc.) and instructions that can be used, for example, by the processor 106 to execute at least a portion of process 200 described below in connection with FIG. 2. The memory 108 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc.

In some examples, the system components 104 of the server 102 can further include the communications subsystem to provide a communication interface from the server 102 and external computing devices via the communication network 120, including local area networks (LANs), wide area networks (WANs) (e.g., the Internet), and various wireless telecommunications networks. In some examples, the communications subsystem may include, for example, one or more network interface controllers (NICs), such as Ethernet cards, Asynchronous Transfer Mode NICs, Token Ring NICs, and the like, as well as one or more wireless communications interfaces, such as wireless network interface controllers (WNICs), wireless network adapters, and the like. Additionally, and/or alternatively, the communications subsystem may include one or more modems (telephone, satellite, cable, ISDN), synchronous or asynchronous digital subscriber line (DSL) units, Fire Wire® interfaces, USB® interfaces, and the like. The communications subsystem can also include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem may also receive input communication in the form of structured and/or unstructured data feeds, event streams, event updates, and the like, on behalf of a user who may access the web page or the website of the web server 140 via the server 102. In an example, the communications subsystem may be configured to receive an input (e.g., a website address, a mouse click input, a keyboard input, etc.) in real-time from users and/or other communication services. Additionally, the communications subsystem 232 may be configured to receive the website (e.g., a Hypertext Markup Language (HTML) file, a JavaScript file, an image file, a video file, etc.) from the web server 140 or any other suitable data in the form of continuous data streams and/or non-continuous data. In some examples, the communications subsystem may output a modified website data from the web server 140 to the client device 130. The various physical components of the communications subsystem may be detachable components coupled to the server 102 via a computer network (e.g., the communication network 120), a FireWire® bus, or the like, and/or may be physically integrated onto a motherboard of the server 102. In some examples, the communications subsystem may be implemented in whole or in part by software.

In some examples, the server 102 can further include the browser 110 (e.g., a remote browser). In some examples, the server 102 can assign a thread or a processing resource to the browser 110 such that the browser 110 can execute a browsing task (e.g., loading a web page from a web server, rendering content, etc.). In some examples, the server 102 can assign a single thread to a tab of the browser 110 such that the tab performs a browsing task until the tab is closed. The browser 110 can be a remote browser and/or an isolated browser, which is an application for accessing the websites where the browser can run in a sandbox or a restricted and isolated environment. In some examples, the server 102 can be the only entity capable of interacting with the browser and the agent. In some examples, the browser 110 downloads the HTML file and other resources (e.g., JavaScript file) from the web server of the web page and then process the web page on the browser to transmit a rendered image to the local device 130 to display the web page's content. Thus, the local device 130 does not need to directly access the web page or the website.

In some examples, the agent 112 can be a program, a program code, a proxy (e.g., a Javascript proxy) stored in the memory 108 in the server 102 or the memory in the isolation server 101. For example, the agent 112 can be written in JavaScript or any other suitable programing language. The processor 106 of the server 102 or the processor of the isolation server 101 can load the agent 112 to the browser 110. In some examples, the processor 106 of the server 102 or the processor of the isolation server 101 can load the agent 112 from the memory to the browser 110 before loading the web page from the web server 140. In some examples, the agent 112 is configured to replace or override a first function (e.g., canvas drawing functions) and/or built-in functions (e.g., JavaScript functions) with a second function (e.g., an agent drawing function defined by the agent), intercept a canvas element on the web page, and/or notify the server when the client device needs to redraw that canvas element. Also, the agent 112 can independently manage a timer and conversion of the canvas. In some examples, the agent 112 along with the browser 110 can be logically or physically separated from the isolation server 101. In some examples, at least part of the process 200 in connection with FIG. 2 can be processed by the browser 110 and/or agent 112 using the processor 106 of the server 102. In some examples, although the isolation server 101 can load the agent 112 into the browser 110, the isolation server 101 may not need to maintain communication until the agent sends the isolation server 101 the drawing to be transmitted to the client device 130.

In some examples, the browser 110 can downloads the website resources (e.g., the HTML, JavaScript file) from the web server 140 and/or access other resources (e.g., a video stream or images). The web server 140 can be computer software and underlying hardware that accepts requests via a suitable communication protocol (e.g., HTTP) to allow the browser 110 to download and/or interact with resources (such as HTML files, JavaScript files, images, CSS files, etc.). In some examples, the web server 140 responds to requests from the browser 110, providing website resources and other resources to the browsers over the internet. However, the web server 140 is not necessarily a reliable source. The web server 140 can include potentially harmful code or malicious content, which can endanger user's data and security. Thus, the browser can contain the potentially harmful code or malicious content from the web server 140 in an isolated environment.

Due to the ever-changing nature of computers and networks, the description of the computing system 100 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

FIG. 2 is a flow chart illustrating an example process 200 for processing web contents (e.g., canvas sanitization), in accordance with various embodiments. As described below, a particular implementation can omit some or all illustrated features, and can not require some illustrated features to implement all embodiments. In some examples, the server 102 with the processor 106 and the memory 108 can be configured to carry out the process 200. In other examples, the server 102 and/or the isolation server 101 in combination (collectively referred to as the server 102) can be configured to carry out the process 200. In some examples, any suitable apparatus or means for carrying out the functions or algorithm described below may carry out the process 200.

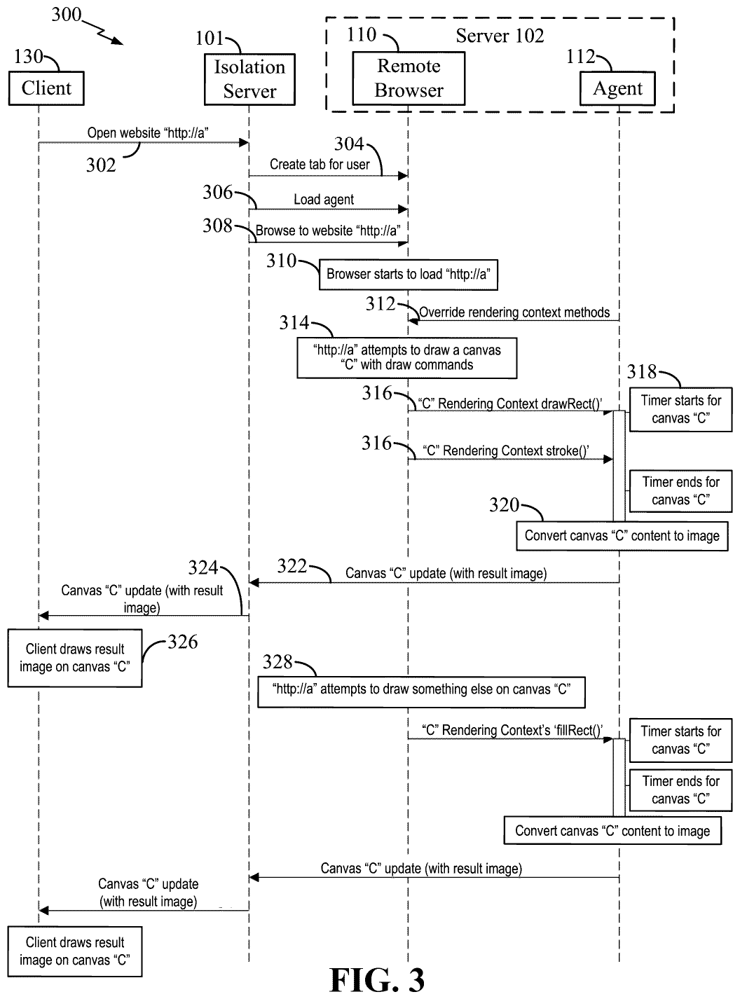

At block 210, the server 102 can receive a request to open a web page or a website from a client device 130 (e.g., through the isolation server 101). Referring to step 302 of FIG. 3, the client device 130 can transmit the request to open a web page to the isolation server 101, and the isolation server 101 receives the request from the client device 130 and transmit the request to the server 102. For example, the request to open a web page from the client device 130 can include a user input (e.g., a website address entry, a mouse click or any input to be redirected to the web page, a voice command to open the web page, or any other suitable user input) on a local browser of the client device 130. In some scenarios, the user can enter a website address on the local browser of the client device 130. Then, the local device 130 can transmit the website address to the server 102 (e.g., through the isolation server 101). In some examples, a web page can include a document, a HTML file, a JavaScript file, CSs file, an image, a video stream, or any suitable document on the World Wide Web and can be identified by a unique uniform resource locator (URL).

In some examples, the local device 130, the isolation server 101, or the server 102 can determine whether the web page to open is safe. In some examples, the local device 130 can determine whether the web page is safe. For example, the local device 130 can store a list of safe or verified website addresses or domain in the memory of the local device 130. Then, when the user enters a website address on the local browser, the local device 130 can search the website address in the list of safe or verified website addresses (e.g., using a lookup table, a hash algorithm, etc.). If the website address or the domain is a safe or verified web page, the client device 130 can directly connect to a web server 140 of the safe web page and download the web page (e.g., a HTML file, a JavaScript file, CSs file, an image, a video stream, etc.) or website resource to be rendered on the local browser. In other examples, the client device 130 can transmit the user input to the server 102 (e.g., through the isolation server 101), and the server 102 or the isolation server 101 can determine whether the web page is safe or verified. If the website address or the domain is safe or verified, the server 102 can connect to the web server 140 and provide the web page and/or web page resource from the web server 140 to the client device 130 (e.g., through the isolation server 101) without using the canvas sanitization process 200. In further examples, the server 102 can determine whether to perform the process 200 by searching any HTML canvas element on the web page from the web server 140. When an HTML canvas element exists on the web page, the server 102 can perform the process 200.

At block 220, the server 102 can, via an agent 112, replace a first function with a second function. In some examples, In some examples, to replace the first function, the server 102 or the isolation server 101 can load the agent 112 from the memory of the server 102 or the isolation server 101 to the browser 110. This is also shown in step 306 of FIG. 3. In some examples, the first function can include a predefined drawing function, a HTML canvas drawing function (e.g., line, path, rectangle, circle, arc, Bezier curve, etc.), a web standard function, a built-in drawing function (e.g., built-in Javascript drawing function), or any other suitable drawing function. Thus, a user can use the first function without newly defining how to draw to a browser. However, by loading the agent 112, the server 102, via the agent 112, can redefine the first function to the second function, which can be an agent drawing function. In some examples, the second function can be a function defined by the agent 112 to perform a task corresponding to the first function. For examples, the second function can be an agent drawing function to perform a predefined drawing function, a HTML canvas drawing function (e.g., line, path, rectangle, circle, arc, Bezier curve, etc.), a web standard function, a built-in drawing function (e.g., built-in Javascript drawing function), or any other suitable drawing function corresponding to the first function. Since the first function on a HTML canvas can be exploited for unauthorized access to an end-user system, the server via the agent 112 can replace the first function with the second function. In further examples, a function (e.g., the first function or the second function) can include a procedure or a set of statements that perform a task (e.g., calculating a value, producing letters, drawing a drawing, etc.) with an output (e.g., the task result, the calculated value, the letters, the drawing, etc.). In further examples, replacing the first function can include replacing or overriding the first function with the second function. For example, the first function is defined in a parent class while the second function is newly defined (e.g., in a child class) with the same function name, parameters, and the return type. Then, when the first function, which is a predefined and standard function, is called, the second function rather than the first function can be performed because the second function overrides the first function.

In some examples, the first function can include a predefined drawing function, a HTML canvas drawing function to draw a drawing (e.g., line, path, rectangle, circle, arc, Bezier curve, etc.), a built-in drawing function (e.g., built-in Javascript drawing function), or any other suitable drawing function. In further examples, the agent 112 can include a proxy (e.g., a Javascript proxy), a code, a set of program statements to intercept the first function and/or redefine the first function to an agent drawing function, which is the second drawing function. Also, the proxy can indicate a programming object, a wrapper, or a program function to intercept the first function and replace the first function with the second function. The proxy can execute code before and after the function is called, in the same context as the function application. In further examples, the agent 112 can possess a prototype function of a given object and any other suitable functions. In some examples, the second function is described in connection with block 240 of FIG. 2. In some examples, to load the agent 112, the server 102 can insert the agent 112, which includes a programming code, in the header to be executed before the web page is loaded and executed. In further examples, to load the agent 112, the server 102 can run, execute, or perform the agent 112 to intercept and/or override the first function, which will be used on the web page. In some examples, before loading the agent 112 to the browser 110, the server 102 can create a tab on the browser 110 as shown in step 304 of FIG. 3. In such examples, to load the agent to the browser 110, the server 102 can load the agent 112 to the tab of the browser 110. Since the server 102 loads the agent 112 to the browser 110, the browser 110 does not need to be modified. The loading of the agent 112 can simplify a canvas sanitization process and improve the versatility because any remote browser without modification can be used for the canvas sanitization process. Also, the loading of the agent 112 can improve the security of the browser because the agent 112 is only used when the canvas sanitization process is performed and/or until the processing resource is assigned to the browser and the standard browser does not need to be modified.

Referring again to FIG. 2, at block 230, the server 102 can load, via the browser 110, the web page from the web server 140. This is also shown in steps 308 and 310 of FIG. 3. For example, the server 102 can provide the web page to the browser 110 at step 308, while the browser 110 loads the web page from the web server 140 at step 310. In some examples, the web page can include a document, a HTML file, a JavaScript file, a CSS file, etc. to render the content from the web server 140 on the browser. In further examples, the web page can include an HTML canvas element. For example, to load the web page, the server 102 can receive the web page from the web server 140 and generate a drawing object of an HTML canvas element on the browser based on the web page. For example, the drawing object of the HTML canvas element can be defined from a rendering context class (e.g., HTMLCanvasElement.getContext(contextType)). In some examples, HTMILCanvasElement.getContext(contextType) as the rendering context class can return a drawing context or a drawing object on the canvas, which can be defined in an HTML file. In some examples, the contextType can be ‘2d’ to generate a drawing object representing a two-dimensional rendering context, ‘webgl,’ ‘webgl2,’ or ‘webgpu’ to generate a drawing object representing a three-dimensional rendering context, or any other suitable context type. In further examples, the drawing object of the HTML canvas element can include a drawing function (e.g., line, path, rectangle, circle, arc, Bezier curve, etc.). However, in some examples, the drawing function can be exploited for unauthorized access to an end-user system.

Referring again to FIG. 2, at block 240, the server 102 can perform, via the agent 112, the second function corresponding to the first function to generate a drawing for a first period of time in response to an attempt to perform the first function on the web page. In some examples, the first period of time can include a predetermined period of time (e.g., 0.1, 0.5, 1, 2, 5, 10 seconds or any other suitable period of time). This is also shown in step 312 of FIG. 3. In some examples, the drawing can include a line, a path, a rectangle, a circle, a Bezier curve, or any suitable object, which can be rendered on the browser 110. In some examples, the first function can be performed based on the same drawing object. In some examples, the first function can include a drawing parameter. For example, the drawing parameter can be provided from the web server 140. In some scenarios, to perform the second function, the server 102 can perform the second function based on the drawing parameter. In some examples, the attempt to perform the first function can include completing a command on the web page prior to a call of the first function or being ready to execute the first function. In some examples, the call of the first function can include executing the first function of a drawing object.

In some examples, the server 102 can receive a user input to indicate a change to the drawing object. In some examples, the attempt to perform the first function can include the change to the drawing object. For example, when the web page includes a drawing function code on the HTML canvas when the mouse pointer is on the canvas. Then, in response to the location of the mouse pointer (i.e., the user input), the first function is configured to be performed. However, the server 102 can intercept the first function and perform, via the browser, the second function. In some examples, each indication triggered by a user input can include a unique identifier for the drawing function on the canvas. Thus, the server 102 can respond differently to each indication. The indication regarding a change made to the canvas element can occur multiple times while the web page is running.

In some examples, the agent 112 can include a utility function, which enable to hook relevant function within all relevant rendering context. For example, the utility function can work by replacing a function belonging to a specific prototype. By replacing a function, any objects utilizing that prototype can employ the agent 112. The first function can be replacing with a dynamically created definition that calls a function of the agent 112 (e.g., a proxy) with the same context as the first function, a reference to the first function to be used in an exception, and the original set of arguments used in the first function passes to the agent 112 to work the same as the first function. In other examples, the agent 112 can replace the drawing object or context (e.g., HTMLCanvasElement.getContext(contextType)) with an agent object. In such examples, the browser 110 can use the predefined drawing method to generate a drawing based on the replaced drawing object.

In response to the attempt, the server 102 can perform, via the agent, the second function corresponding to the first function to generate a drawing for a period of time. In some examples, the period of time can include a predetermined period of time (e.g., 0.1, 0.5, 1, 2, 5, 10 seconds or any other suitable period of time). This is also shown in steps 316 and 318 of FIG. 3. In some examples, the second function can be configured to draw a line, a path, a rectangle, a circle, an arc, a Bezier curve, or any other suitable shape from the drawing object or the rendering context class (e.g., HTMLCanvasElement.getContext(contextType)). In some examples, the second function can include beginPath( ), arc( ), moveTo( ), lineTo( ), stroke( ), or any other suitable function to draw. In some examples, the second function can draw the same drawing that the corresponding first function is supposed to draw. In some examples, to perform the second function, the server 102 can perform the second function on the browser based on the drawing object. Thus, the second function is performed based on the same drawing object on which the first function is based. For example, when the first function is configured to draw a circle based on the drawing object on the canvas, the second function can just draw a circle based on the same drawing object on the canvas. In some examples, the drawing can include an object drawn by the second function. Thus, the web page can run normally and unaware that the agent function is called instead of the first function. This is because the agent 112 intercepts a function rather than intercepting web traffic, which is used in existing technologies.

In some examples, the server 102 can initiate a timer for the period of time. In some examples, the timer can be associated with the drawing object. Referring again to FIG. 3, after initiating the timer, the server 102 can operates on the canvas element within the server environment. For example, the server 102 may call an agent function (e.g., beginPath( ), arc( ), moveTo( ), lineTo( ), stroke( ), etc.). In further examples, the period of time for the timer can be static and can be configured differently for various web pages. Thus, while the timer is active, all drawing calls associated with the same drawing object or context can continue to operate normally, without resetting the timer.

In further examples, the drawing can be a first partial drawing. Then, the server can perform, via the agent, the second function corresponding to the first function to generate a second partial drawing for a second period time. In some examples, the second period of time can include a predetermined period of time (e.g., 0.1, 0.5, 1, 2, 5, 10 seconds or any other suitable period of time). Then, the server 102 can aggregate, via the agent, the first partial drawing and the second partial drawing to generate an aggregated drawing.

Referring again to FIG. 2, at block 250, the server 102 can convert, via the agent, the drawing to an image. In some examples, the drawing can a line, a path, a rectangle, a circle, an arc, a Bezier curve, or any other suitable object on the canvas (e.g., drawn by a HTML canvas drawing function, a built-in drawing function, or any other suitable drawing function). In further examples, the image can be a binary representation of the canvas including the drawing. For example, the image can be stored in various format (e.g., TIFF, JPEG, PNG, GIF, or any other suitable format). This is also shown in step 320 of FIG. 3. In the examples in block 240 with aggregating the first and second partial drawings to the aggregated drawing, the server 102 can convert, via the agent, the aggregated drawing to the image. In the examples with the drawing including the object drawn by the second function, the server 102 can convert, via the agent, the object rather than the entire rectangular area including the object to the image. In some examples, the server 102 can convert, via the agent 112, the drawing to an image (e.g., using the “toDataURL” method of HTMLCanvasElement. By converting the actual canvas element rather than the area it renders on the screen, the effects of background images or videos beneath or above the canvas layer can be eliminated. In further examples, by choosing a certain image format (e.g., PNG), which supports transparency, the canvas may not obstruct any elements intended to be behind it in the browser. Since the copy does not include any other data except for the information of the pixels itself, it cannot contain any malicious data that might be stored in rendering contexts due to a vulnerability in the browser's implementation of such contexts. Further, the image is in the exact size for the canvas, as it is a copy of the canvas' pixels and not generic drawing instructions, providing better final image quality to the client device 130.

In some examples, when the drawings can include multiple partial drawings based on the timer, the server 102, can convert, via the agent 112, each partial drawing to an image. In other examples, the server 102, can aggregate, via the agent 112, the multiple partial drawings to generate an aggregated drawing and convert aggregated drawing to an image. In further examples, the server 102, can convert, via the agent 112, each partial drawing to an image. Then, the server 102 can aggregate, via the agent 112, the images corresponding to partial drawings to generate an image.

Referring again to FIG. 2, at block 260, the server 102 can transmit, (e.g., via the agent 112 and/or the communication subsystem), the image to the client device 130 (e.g., through the isolation server 101). This is also shown in steps 322 and 324 of FIG. 3. In some examples, the agent 112 can transmit the image in the sandbox to the isolation server 101, which transmits the image to the client device 130. Then, the client device can draw the result image on the drawing object as shown in step 326 in FIG. 3. embodiments.

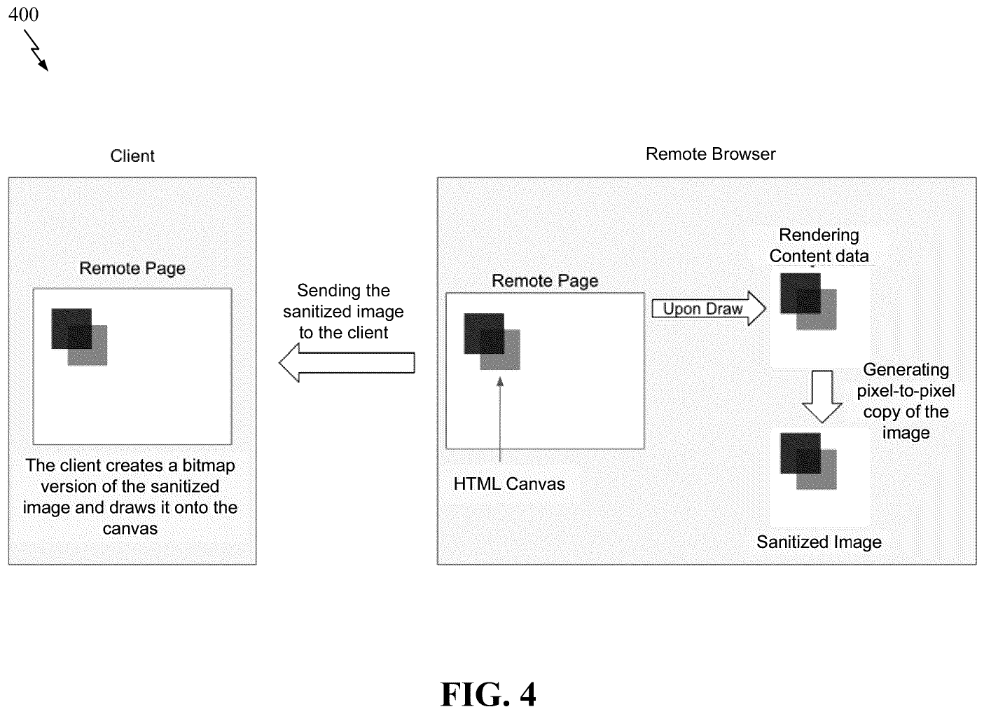

This process can be repeated when the web page attempts to draw something else on the drawing object as shown in step 328 in FIG. 3. FIG. 4 is an example schematic diagram illustrating example canvas sanitization. The agent 112 loaded to the browser 110 can intercept and replace drawing functions of the web page with agent functions to generate a drawing. Then, the agent 112 can generate pixel-to-pixel copy of the image of the drawing and send the sanitized image to the client device 130. The client device 130 can create a bitmap version of the sanitized image and draws the image onto the canvas of the local browser. Thus, the process 200 does not need to modify the browser 110 by loading the agent 112 to the browser 110 and reduce computing resource usage by intercepting drawing functions rather than web traffic.

While particular features and aspects have been described with respect to some embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while particular functionality is ascribed to particular system components, unless the context dictates otherwise, this functionality need not be limited to such and can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—particular features for ease of description and to illustrate some aspects of those embodiments, the various components and/or features described herein with respect to a particular embodiment can be substituted, added and/or subtracted from among other described embodiments, unless the context dictates otherwise. Consequently, although several embodiments are described above, it will be appreciated that the invention is intended to cover all modifications and equivalents within the scope of the following claims.

What is claimed is:

1. A method for processing web contents, comprising:
receiving a request to open a web page from a client device;
replacing, via an agent, a first function with a second function, the agent being loaded to a browser;
loading the web page from a web server to the browser;
in response to an attempt to perform the first function on the web page, performing, via the browser, the second function corresponding to the first function to generate a drawing for a first period of time;
converting, via the agent, the drawing to an image; and
transmitting the image to the client device.

2. The method of claim 1, wherein the agent being loaded to the browser is prior to the loading of the web page from the web server to the browser.

3. The method of claim 1, wherein the agent comprises a proxy, and
wherein the replacing of the first function comprises: redefining the first function to the second function.

4. The method of claim 3, wherein the first function is configured to be performed using a drawing parameter, and
wherein the second function is configured to be performed using the drawing parameter.

5. The method of claim 1, wherein the loading of the web page comprises:
receiving the web page from the web server; and
generating a drawing object of a hypertext markup language canvas element on the browser based on the web page, wherein the first function is configured to be performed based on the drawing object.

6. The method of claim 5, wherein the performing of the second function comprises:
performing the second function on the browser based on the drawing object.

7. The method of claim 5, further comprising:
initiating a timer for the first period of time, wherein the timer is associated with the drawing object.

8. The method of claim 7, wherein the drawing comprises a first partial drawing,
wherein the method further comprises:
performing, via the agent, the second function corresponding to the first function to generate a second partial drawing for a second period of time; and
aggregating, via the agent, the first partial drawing and the second partial drawing to generate an aggregated drawing, and
wherein the converting of the drawing comprises: converting the aggregated drawing to the image.

9. The method of claim 5, further comprising:
receiving a user input to indicate a change to the drawing object,
wherein the change to the drawing object comprises the attempt to perform the first function.

10. The method of claim 1, wherein the attempt to perform the first function comprises: completing a command on the web page prior to a call of the first function.

11. The method of claim 1, wherein the drawing comprises an object drawn by the second function, and
wherein the converting of the drawing comprises: converting the object to the image.

12. A server comprising:
a memory storing a browser and an agent;
a processor coupled to the memory, and
a communication system coupled to the processor,
wherein the processor coupled to the memory is configured to:
receive, via the communication system, a request to open a web page from a client device;
replace, via an agent, a first function with a second function, the agent being loaded to the browser;
load, via the browser, the web page from a web server;
in response to an attempt to perform the first function on the web page, perform, via the agent, the second function corresponding to the first function to generate a drawing for a first period of time;
convert, via the agent, the drawing to an image; and
transmit, via the communication system, the image to the client device.

13. The server of claim 12, wherein the agent comprises a proxy, and
wherein to replace the first function, the processor is configured to: redefine the first function to the second function.

14. The server of claim 13, wherein the first function comprises a drawing parameter, and
wherein to perform the second function, the processor is configured to:
perform the second function based on the drawing parameter.

15. The server of claim 12, wherein to load the web page, the processor is configured to:
receive the web page from the web server; and
generate a drawing object of a hypertext markup language canvas element on the browser based on the web page, wherein the first function is configured to be performed based on the drawing object.

16. The server of claim 15, wherein to perform the second function, the processor is configured to:
perform the second function on the browser based on the drawing object.

17. The server of claim 15, wherein the processor is further configured to:
initiate a timer for the first period of time, wherein the timer is associated with the drawing object.

18. The server of claim 17, wherein the drawing comprises a first partial drawing,
wherein the processor is further configured to:
perform, via the agent, the second function corresponding to the first function to generate a second partial drawing for a second period of time; and
aggregate, via the agent, the first partial drawing and the second partial drawing to generate an aggregated drawing, and
wherein to convert the drawing, the processor is configured to: convert the aggregated drawing to the image.

19. The server of claim 15, wherein the processor is further configured to:
receive a user input to indicate a change to the drawing object,
wherein the change to the drawing object comprises the attempt to perform the first function.

20. A server comprising:
a memory storing a browser and an agent;
a processor coupled to the memory, and
a communication system coupled to the processor,
wherein the processor coupled to the memory is configured to:
receive, via the communication system, a request to open a web page from a client device;
loading an agent to the browser;
replace, via the agent, a first function with a second function;
load, via the browser, the web page from a web server;
in response to an attempt to perform the first function on the web page, perform, via the agent, the second function corresponding to the first function to generate a drawing for a first period of time;
convert, via the agent, the drawing to an image; and
transmit, via the communication system, the image to the client device.
